(19) United States
(12) Patent Application Publication
(10) Pub. No.: US 2009/0295144 A1
(43) Pub. Date: Dec. 3, 2009

(54) System and Method for Printing, Protecting and Authenticating Packaging, Tangible Entertainment Media and Other Printed Products

(76) Inventor: Karin-Maria K. Winkelhorn, Las Vegas, NV (US)

Correspondence Address: Locke Lord Bissell & Liddell LLP;Attn: Michael Ritchie, Docketing, 2200 Ross Avenue, Suite # 2200, DALLAS, TX, 75201-6776, US

(21) Appl. No.: 12/131,566

(22) Filed: Jun. 2, 2008

(51) Int. Cl. B42D 15/00

(52) U.S. Cl. 283/94

(57) ABSTRACT

A system and method for printing, protecting and authenticating packaging, tangible entertainment media and other products, including a combination of encoded numbers, letters or images (collectively, “indicia”) that is embedded into or printed onto a substrate at a location that is in plain view when incorporated into a package or product; a clear or translucent coating applied in a decoding pattern over the encoded portion of the substrate in such manner that the encoded indicia are readily viewable by and intelligible to a viewer; and an authenticating combination of indicia that is hidden from plain view and becomes visible to an authorized viewer only through destruction of the package or through close inspection of the product. Alternatively, the system can comprise an authenticating combination that is accessible to an authorized purchaser from a separate source or object, and possibly from a remote location.

### BACKGROUND OF THE INVENTION

1. Field of the Invention

This invention relates to an inexpensive, effective and adaptable system and method for verifying the authenticity of packaging, tangible entertainment media and other products. One aspect of the invention relates to an authentication system that comprises at least one decodable security element positioned in plain view on packaging or a product in combination with at least one corroborating security element that is hidden from plain view, except to authorized viewers, without tampering or destruction of a portion of the package or product. Another aspect of the invention relates to a method for authenticating packages or products by which an encoded number, word or image can be applied to paper and/or other inexpensive substrates and rendered visible or intelligible by a clear or translucent coating applied in a decoding pattern, which is then verified or corroborated from another source that is accessible to an authorized purchaser.

2. Description of Related Art

Artisans, manufacturers, sellers, purchasers and consumers of many different products and articles of commerce are well attuned to the presence in the marketplace of unauthorized, counterfeit or fraudulently misrepresented goods. Various systems and methods have previously been used or suggested to differentiate between genuine and unauthorized packages and products. In some cases, the unauthorized goods or products are readily identifiable “knock-offs” of inferior quality. Of potentially greater concern are unauthorized goods or products that are of comparable quality, sometimes made by the same manufacturers who make the authorized goods, but are virtually indistinguishable from the authorized originals unless some other means is provided for verifying their authenticity.

Historically, watermarks were used for artistic and authentication purposes on paper products and other printed goods. More recently, holograms and lenticular printing have been applied to plastic substrates both for artistic effects (such as image flipping, morphing, zooming, or creating 3-D effects or an illusion of motion) and to identify the related articles as being genuine. Unfortunately, both holograms and lenticular printing typically require the use of relatively high-cost substrates and expensive printing presses and processes requiring, for example, printing on both sides of a clear plastic substrate. A system and method for protecting and authenticating packaging and products are therefore needed that will facilitate the use of a greater variety of less-expensive substrates, that can be implemented using lower-cost, conventional presses, and that will provide a higher level of security and protection from copying or counterfeiting.

### SUMMARY OF THE INVENTION

A system and method for printing, protecting and authenticating packaging, tangible entertainment media and other products are disclosed. The system and method disclosed herein will preferably enhance the collect ability, security, authentication and entertainment value of items with simple, plain paper surface printing. One significant advantage of the system and method of the invention is that it useful for producing text or graphic images exhibiting apparent visual effects such as motion or animation, dimension, and the like, by encoding a first image on a substrate and subsequently overlaying the first image with a clear or translucent coating applied in a decoding pattern to achieve the desired visual effect. The visual effects produced on packaging using the system and method of the invention as implemented by printing on only one side of regular paper can be achieved at lower cost and with a lighter resultant package weight compared to packages made from plastic sheet material where the visual effect is created by printing on two sides.

According to one preferred embodiment of the invention, an authentication system is disclosed that comprises the following elements: (1) a first, preferably unique, combination of encoded numbers, letters or images (collectively, “indicia”) that are embedded into or printed onto a substrate at a location that will be in plain view when incorporated into a package or product; (2) a clear or translucent coating applied in a decoding pattern over the encoded portion of the substrate in such manner that the encoded indicia are readily viewable by and intelligible to a viewer; and (3) an authenticating combination of numbers, letters and/or images that is hidden from plain view and becomes visible to an authorized viewer only through destruction of the package or through close inspection of the product.

According to another preferred embodiment of the invention, a method for authenticating products and packaging is disclosed that comprises: applying to a product or package a first, preferably unique, combination of encoded numbers, letters and/or images (collectively, “indicia”) that are embedded into or printed on a printable surface of the package or product that is in plain view; applying a clear or translucent coating in a decoding pattern over the encoded portion of the package or product so that the previously encoded indicia are readily viewable by and intelligible to an authorized viewer; and applying to the product or package, preferably in a position not viewable without tampering by someone other than an authorized viewer, an authenticating combination of numbers, letters and/or images that authenticates the package or object when compared to the first indicia.

According to another embodiment of the invention, a product authentication system is disclosed that comprises a substrate having encoded indicia printed on the substrate, which printed indicia is covered with a clear ink coating that functions as a lens to decode the printed indicia.

According to another embodiment of the invention, a product authentication system is disclosed that comprises a substrate having encoded indicia printed on the substrate, which is in turn covered with a clear ink coating that is overlaid with a black mask to decode the printed indicia.

Alternatively, when using the system and method of the invention, an authenticating combination of indicia can be made accessible to an authorized purchaser from a separate source or object, and possibly from a remote location, such as by using a website or toll-free phone number.

### BRIEF DESCRIPTION OF THE DRAWINGS

The apparatus of the invention is further described and explained in relation to the following drawings wherein:

FIG. 1 is a simplified perspective view of a sealed package comprising a visible authentication element and a hidden authentication element;

FIG. 2 is an enlarged cross-sectional view, partially broken away, taken along line 2-2 of FIG. 1, showing encoded indicia embedded into (or, alternatively, printed onto) the surface of a substrate forming a portion of an end wall of the package, with a decoding pattern coated over the encoded indicia;

FIG. 3 is a simplified front perspective view of a handbag bearing a visible brand name and having a hangtag also bearing the visible brand name;

FIG. 4 is a simplified front perspective view of the hangtag of FIG. 2 still shown in the closed position;

FIG. 5 is a simplified front perspective view of the hangtag of FIG. 3 shown in the open position, with the authentication field hidden by a scratch-off coating;

FIG. 6 is the hangtag of FIG. 4, partially broken away, with most of the scratch-off coating removed to reveal the legend “AUTHENTIC” that was previously hidden beneath the scratch-off coating;

FIG. 7 is a simplified diagrammatic view of a system comprising a package as shown and described in relation to FIG. 1 in combination with an authentication disc that is readable by a computer, and a cell phone that is communicating electronically with a remote authentication center;

FIG. 8 is a cross-sectional detail view, partially broken away, of a paper substrate having encoded indicia printed on the substrate, which is in turn covered with a clear ink coating that functions as a lens to decode the printed indicia; and

FIG. 9 is a cross-sectional detail view, partially broken away, of a paper substrate having encoded indicia printed on the substrate, which is in turn covered with a clear ink coating that is overlaid with a black mask to decode the printed indicia.

### DESCRIPTION OF PREFERRED EMBODIMENTS

The system and method disclosed herein are believed to be useful for enhancing, protecting and/or authenticating a broad variety of products, either by direct application to the products, or by application to a label or hangtag that is affixed or attachable to the items, or by application to packaging in which such products are sealed for display or sale. Such products can include, for example and without limitation, health and beauty products such as perfumes, colognes, make-up, and the like; personal accessories such as handbags, luggage, watches, jewelry, designer glasses, and the like; apparel items such as suits, coats, dresses, shoes and the like; business products such as applications software, manuals, electronic components, peripheral devices, and the like; inherently valuable documents such as passports, stamps, paper currency, negotiable securities, diplomas, degrees, and the like; other printed products such as magazines, magazine ads, calendars, books, comic books, sheet music, tickets, stamps, food wrapping, decorative packaging, and the like; entertainment products such as compact discs, digital video discs, games, and the like; electronic devices such as cameras, televisions, recorders, players, and the like; artistic products such as paintings, sculptures, photographs, and the like; collectable items such as limited edition prints, athletic trading cards, sound recordings, rare objects, celebrity memorabilia, and the like; and security packaging for consumer goods. The system and method of the invention are believed to be particularly useful for protecting and authenticating packages and products that are manufactured in large quantities because they can be implemented using high speed machines and relatively inexpensive materials, particularly paper, as substrates.

According to a preferred embodiment of the system of the invention, an authentication system is desirably disclosed that comprises the following elements: (1) a first, preferably unique, combination of encoded numbers, letters or images (collectively, “indicia”) that are embedded into or printed onto a substrate at a location that will be in plain view when incorporated into a package or product; (2) a clear or translucent coating applied in a decoding pattern over the encoded portion of the substrate in such manner that the encoded indicia are readily viewable by and intelligible to a viewer; and (3) an authenticating combination of numbers, letters and/or images that is hidden from plain view and becomes visible to an authorized viewer only through destruction of the package or through close inspection of the product.

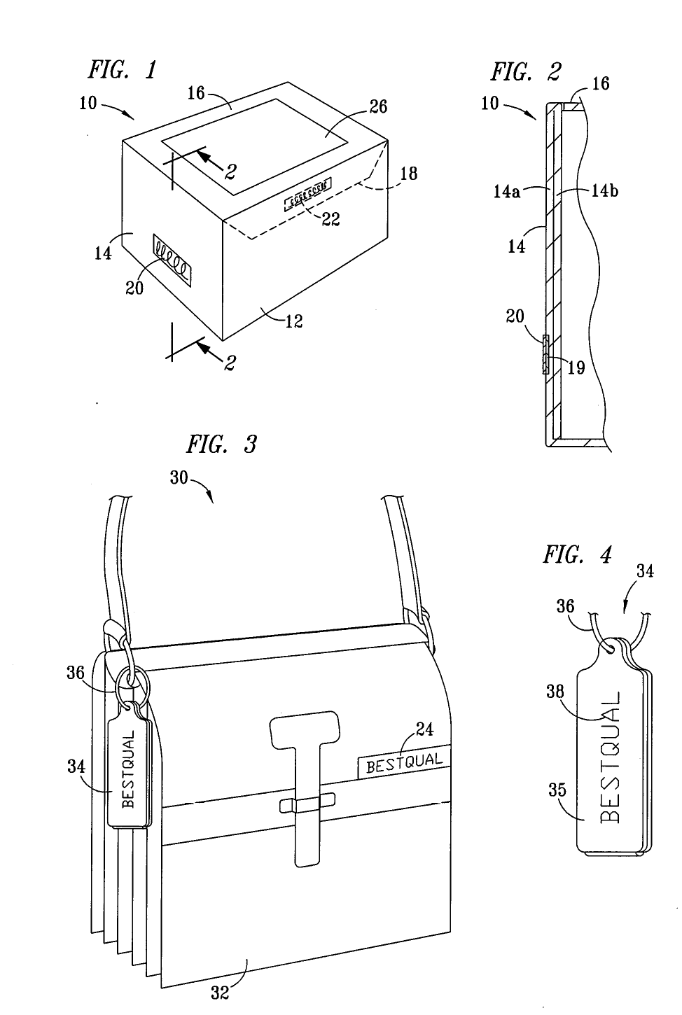

Referring to the embodiment of the invention as shown in FIG. 1, package 10 is sealed, contains a product (not visible), and comprises top, bottom, front, back and end walls of which front wall 12, end wall 14 and top 16 are visible. Flap 18 of top 16 is tucked behind front wall 12, and is most preferably sealed in that position so that printable area 22 is not visible to an authorized purchaser until such time as package 10 is opened at or subsequent to the time of sale. Any adhesive or other type of seal applied to flap 18 will desirably not destroy or damage the authenticating combination that is printed in area 22. An authorized purchaser can desirably determine that package 10 is authentic and from an approved source by opening the package and comparing the indicia printed in area 22 to that printed in area 20.

Package 10 is preferably fabricated from a die-cut sheet of a suitable substrate that is folded, thermoformed or otherwise constructed, and sealed following insertion of a product inside the package. Although inexpensive paper or cardboard substrates are preferred for use in making packages, hangtags, and the like, for use in the invention, it should be recognized that substrates suitable for practicing the invention can comprise, for example and without limitation, polymeric materials, paper, cardboard, wood pulp, cloth, reflective foils, or laminates or composites thereof, and the like, provided that such substrates comprise at least one printable surface area. Most preferably, package 10, when assembled, will include at least one visible printable surface area and at least one printable surface area that is hidden from view except to an authorized purchaser. Framed area 26 on top 16 of package 10 is depicted simply as an example of another, relatively larger, printable surface area where text or graphics, can optionally be displayed for visual purposes only, and not necessarily for authentication purposes.

Referring to FIGS. 1 and 2, package 10 is desirably fabricated from a printable substrate, most preferably a sheet of heavy paper or cardboard having a first set of encoded indicia 19 that is preferably printed on or embedded in the surface prior to assembly into the surface that becomes outwardly facing surface of outside end wall 14a of package 10 when package 10 is assembled. The substrate can be any thickness that is printable. Alternatively, depending upon the type of substrate used, the encoded indicia can be watermarked or embedded during manufacture or otherwise applied to the substrate. The encoded indicia are preferably designed so that, when coated with a decoding pattern 20 in a subsequently applied clear or translucent layer, a predetermined visual effect will be achieved. Such visual effects can include, for example, apparent motion, flipping between different images, dimensional and spatial effects, and the like, to stimulate consumer interest, make packages more interesting or entertaining, and/or achieve a desired artistic effect.

The encoded indicia and the decoding pattern in the coating layer can be applied to the substrate using conventional presses and techniques such as, for example, line interlacing, barrier interlacing, custom amorphous interlacing, or an encoded cipher. The encoded indicia and the decoding pattern can be applied by a lithographic or flexographic press using commercially available inks that re suitable for printing resolutions within the range of about 50 to about 5000 lines per inch. For example, the encoding of an authentication element can be done by printing 100 lines per inch that are 20% clear and 80% black. The thickness of the clear or translucent coating layer desirably ranges between about 0.001 and about 0.01 inches, and will preferably average about 0.002 inches.

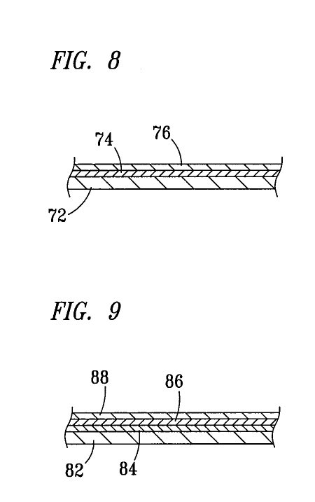

One preferred embodiment of the authentication system of the invention and a method for making it are disclosed in relation to FIG. 8. Referring to FIG. 8, a substrate 72, preferably paper, is printed with an ink layer 74 comprising encoded indicia as described above. A clear ink coating 76 is then applied over the encoded indicia of ink layer 74. Clear ink coating 76 creates a lens system that makes the encoded indicia intelligible to an observer.

Another preferred embodiment of the authentication system of the invention and a method for making it are disclosed in relation to FIG. 9. Referring to FIG. 9, a substrate 82, preferably paper, is printed with an ink layer 84 comprising encoded indicia as described above. A clear ink coating layer 86 that serves as a spacer is then applied above encoded ink layer 84, after which clear coating layer 86 is overlaid with a black mask layer 88 that makes the encoded indicia intelligible to an observer.

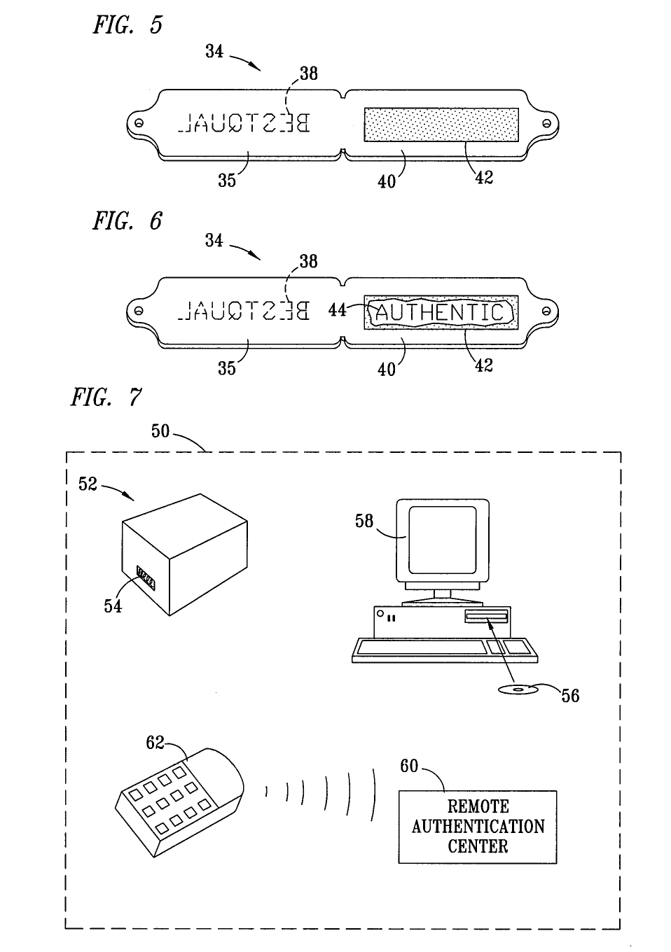

Another application of the authentication system 30 of the invention is disclosed and described in relation to FIGS. 3-6 of the accompanying drawings. Referring to FIG. 2, designer handbag 32 bearing the embossed logo “BESTQUAL” in area 24 is authenticated through use of the invention in relation to hangtag 34 secured by ring 36. Referring to FIGS. 4-6, hangtag 34 can comprise visually stimulating printed indicia 38, simplistically demonstrated here for illustrative ease as the word “BESTQUAL” that is printed in a readily visible area on the front surface of the hangtag. Indicia 38 is desirably printed on top layer 35 of a suitable printable substrate in encoded form as described above in relation to package 10, and is coated with a clear or translucent decoding pattern that creates a desired visual effect that will be apparent to a consumer. Once handbag 32 has been purchased, the consumer will be able verify its authenticity (even at the point of sale) by removing hangtag 34, opening it to reveal hidden area 42 disposed on the inside surface of bottom layer 40. If desired, a previously hidden combination of indicia can be displayed in readily intelligible form on bottom layer 40. In this case, however, the word “AUTHENTIC” 44 is revealed in FIG. 6 by scratching away most of a scratch-off coating 42 that was applied as part of the authenticating combination.

It should be understood that the particular products and authenticating combinations disclosed in relation to the embodiments of FIGS. 1-6 are merely examples of many other embodiments of the subject authentication system that can be devised and implemented in accordance with the invention disclosed herein. Thus, for example, the authenticating combination can be hidden in any portion of a product that is not readily apparent to an uninformed or unauthorized individual, after which the product is sealed inside a package bearing a visually attractive printed display element that itself comprises an encoded combination over layered with a decoding pattern that achieves a desired visual effect and is correlated to the authenticating combination.

Still another alternate embodiment of the invention is disclosed as authentication system 50 in FIG. 7. Referring to FIG. 7, sealed package 52 bears an area 54 having encoded indicia coated with a decoding pattern that is applied in accordance with the parameters disclosed above. The encoded indicia and decoding pattern cooperate to generate a visually stimulating logo, perhaps a readable set of characters, suggesting that the product contained in package 52 is authentic. In this case, however, package 52 can also contain a disc 56 that is readable when inserted into PC 58, or can contain a printed insert bearing a telephone number that can be used with the purchaser's cell phone 62 to reach remote authentication center 60 and verify the authenticity of the purchased product by code, serial number or the like.

Similarly, a method is disclosed herein for authenticating products and packaging by applying to a product or package a first, preferably unique, combination of encoded numbers, letters and/or images (collectively, “indicia”) that are embedded into or printed on a printable surface of the package or product that is in plain view; applying a clear or translucent coating in a decoding pattern over the encoded portion of the package or product so that the previously encoded indicia are readily viewable by and intelligible to an authorized viewer; and applying to the product or package, preferably in a position not viewable without tampering by someone other than an authorized viewer, an authenticating combination of numbers, letters and/or images that authenticates the package or object when compared to the first indicia.

According to another preferred embodiment of the invention, the subject method and system can be implemented using either manual or automatic scanning of visible and hidden serial numbers, symbols or codes for products. Hidden codes can be changed and new codes recorded every time an item, valuable product, piece of currency, or passport, for example, is tested for authenticity. This last level can be used for the highest level of security.

Other alterations and modifications of the invention will likewise become apparent to those of ordinary skill in the art upon reading this specification in view of the accompanying drawings, and it is intended that the scope of the invention disclosed herein be limited only by the broadest interpretation of the appended claims to which the inventor is legally entitled.

1. A system for protecting and authenticating packaging, tangible entertainment media and/or other products, comprising:
a first combination of encoded numbers, letters and/or images that are embedded into or printed onto a substrate at a location that is in plain view on a package or product embodying the substrate;
a clear or translucent coating applied in a decoding pattern over the encoded portion of the substrate in such manner that the combination is readily viewable by and intelligible to a viewer; and
an authenticating combination of numbers, letters and/or images that is hidden from plain view and becomes visible to an authorized viewer only through destruction of the package or through close inspection of a previously hidden portion of the product.

2. The system of claim 1 wherein the substrate is selected from a group of printable materials consisting of paper, cardboard, wood pulp, cloth and plastic, and composites thereof.

3. The system of claim 1 wherein the first combination of encoded numbers, letters and/or images is unique.

4. The system of claim 1 wherein the first combination of encoded numbers, letters and/or images is applied as a coating to the substrate.

5. The system of claim 1 wherein the encoded letters, numbers and/or images embody line interlacing, barrier interlacing, custom amorphous interlacing or an encoded cipher.

6. The system of claim 1 wherein the decoding pattern comprises a line density ranging from about 50 to about 5000 lines per inch.

7. The system of claim 1 wherein the thickness of the coating ranges from about 0.001 to about 0.01 inches.

8. The system of claim 7 wherein the thickness of the coating has an average thickness of about 0.002 inches.

9. The system of claim 1 wherein the authenticating combination is disposed under a surface of a package or product.

10. The system of claim 1 wherein the authenticating combination is disposed inside a package or product.

11. The system of claim 1 wherein the authenticating combination is disposed inside a tag or label accompanying the package or product.

12. The system of claim 1 wherein the authenticating combination is accessible to an authorized purchaser from a separate source or object.

13. The system of claim 12 wherein the separate source is disposed at a location that is remote from the package or product.

14. A method for protecting and authenticating packaging, tangible entertainment media and/or other products, comprising:
applying to a product or package a first combination of encoded numbers, letters and/or images that are embedded into or printed onto a substrate;
applying a clear or translucent coating in a decoding pattern over the encoded portion of the substrate in such manner that the coated first combination is readily viewable by and intelligible to a viewer;
incorporating the substrate into a package or product wherein the first combination of encoded numbers, letters and/or images is disposed at a location that is readily viewable by an authorized user; and
applying to the product or package an authenticating combination of numbers, letters and/or images that authenticates the package or object when compared to the decoded first combination of numbers, letters and/or images, wherein the authenticating combination of numbers, letters and/or images is hidden from plain view on the product or package.

15. The method of claim 14, including selecting the substrate from a group of printable materials consisting of paper, cardboard, wood pulp, cloth, plastic and composites thereof.

16. The method of claim 14 wherein the first combination of encoded numbers, letters and/or images is unique.

17. The method of claim 14 including applying the first combination of encoded numbers, letters and/or images as a coating to the substrate.

18. The method of claim 17 wherein the encoded letters, numbers and/or images embody line interlacing, barrier interlacing, custom amorphous interlacing or an encoded cipher.

19. The method of claim 14 including applying the decoding pattern with a line density ranging from about 50 to about 5000 lines per inch.

20. The method of claim 14 including applying the coating at a thickness ranging from about 0.001 to about 0.01 inches.

21. The method of claim 20 including applying the coating at an average thickness of about 0.002 inches.

22. The method of claim 14 including positioning the authenticating combination so that it is disposed under a surface of a package or product.

23. The method of claim 14 including positioning the authenticating combination so that it is disposed inside a package or product.

24. The method of claim 14 including positioning the authenticating combination so that it is disposed inside a tag or label accompanying the package or product.

25. The method of claim 14 wherein the authenticating combination becomes visible to an authorized viewer only by tampering with the package.

26. The method of claim 14 wherein the authenticating combination becomes visible to an authorized viewer only by closely inspecting a previously hidden portion of the product.

27. The method of claim 14 including making the authenticating combination accessible to an authorized purchaser from a separate source or object.

28. The method of claim 27 wherein the separate source is disposed at a location that is remote from the package or product.

29. A method for producing text or graphic images exhibiting an apparent visual effect to a substrate by applying an encoded array of text and/or image onto at least a portion of at least one surface of the substrate, and subsequently applying a clear or translucent coating to at least a portion of the substrate, the coating comprising a decoding pattern disposed over the encoded array, to produce said apparent visual effect.

30. The method of claim 29 wherein the substrate is paper.

31. The method of claim 29 wherein the substrate is plastic sheet.

32. The method of claim 29 wherein the encoded array is applied by printing.

33. The method of claim 29 wherein the encoded array is embedded in the substrate.

34. The method of claims 29 wherein the apparent visual effect is selected from the group consisting of motion, animation, image flipping, and dimensional and/or spatial effects.

35. The method of claim 29 wherein the encoded array comprises line interlacing, barrier interlacing, custom amorphous interlacing, or an encoded cipher.

36. The method of claim 29 wherein the decoding pattern comprises line interlacing, barrier interlacing, custom amorphous interlacing, or an encoded cipher.

37. The method of claim 29 wherein the decoding pattern comprises a plurality of closely spaced lines.

38. A product made using the method of claim 29.

39. A product made using the method of claim 30.

40. A product made using the method of claim 31.

41. A product made using the method of claim 32.

42. A product made using the method of claim 33.

43. A product made using the method of claim 34.

44. A product made using the method of claim 35.

45. A product made using the method of claim 36.

46. A product made using the method of claim 37.

47. An authentication system comprising a substrate having encoded indicia printed on the substrate, which encoded printed indicia are covered with a clear ink coating that renders the encoded indicia intelligible to an observer.

48. The authentication system of claim 47 wherein the substrate comprises paper.

49. A product embodying the authentication system of claim 47.

50. An authentication system comprising a substrate having encoded indicia printed on the substrate, which printed indicia are covered with a clear ink spacer coating, said clear ink spacer coating being further overlaid with a black mask that renders the encoded indicia intelligible to an observer.

51. The authentication system of claim 47 wherein the substrate is paper.

52. A product embodying the authentication system of claim 50.

53. A method for producing text or graphic images exhibiting an apparent visual effect to a substrate by applying an encoded array of text and/or image onto at least a portion of at least one surface of the substrate, and subsequently applying a clear coating over the encoded array, wherein the clear coating renders the encoded array intelligible to an observer.

54. The method of claim 53 wherein the substrate is paper.

55. A product made by the method of claim 53.

56. A method for producing text or graphic images exhibiting an apparent visual effect to a substrate by applying an encoded array of text and/or image onto at least a portion of at least one surface of the substrate, subsequently applying a clear ink spacer coating over the encoded array, and overlaying the clear ink spacer coating with a black mask that renders the encoded array intelligible to an observer.

57. The method of claim 56 wherein the substrate is paper.

58. A product made by the method of claim 56.
